(19) United States
(12) Patent Application Publication
(10) Pub. No.: US 2017/0245116 A1
(43) Pub. Date: Aug. 24, 2017

(54) INDOOR POSITIONING SYSTEM AND METHOD HAVING IMPROVED ACCURACY

(71) Applicant: Winitech Co., Ltd., Daegu (KR)

(72) Inventors: Kyo Koan Chu, Daegu (KR); Jong Eun Kim, Gyungsan-Si (KR)

(73) Assignee: Winitech Co., Ltd.

(21) Appl. No.: 15/415,739

(22) Filed: Jan. 25, 2017

(30) Foreign Application Priority Data
Feb. 24, 2016 (KR) 10-2016-0021776

(51) Int. Cl. H04W 4/04; H04W 4/02; H04B 17/318

(52) U.S. Cl. CPC H04W 4/043; H04B 17/318; H04W 4/027; H04W 4/023

(57) ABSTRACT

A system and method for indoor positioning is disclosed. The indoor positioning system and method significantly improve accuracy of indoor positioning by measuring an indoor position using radiofrequency (RF) signals output from RF transmitters (e.g. a beacon) and by using position information measured by pedestrian dead reckoning (PDR) using sensing information obtained by sensing movement of a user terminal. For measuring an position inside a building using RF transmitters, error caused by internal structures of the building (walls, doors) can be corrected using spatial information (3D model of the building), positions of the RF transmitters, and information of a predetermined area allowed for user access inside the building.

### CROSS REFERENCE TO RELATED APPLICATION

The present application claims priority from Korean Patent Application Number 10-2016-0021776 filed on Feb. 24, 2016, the entire contents of which are incorporated herein for all purposes by this reference.

### BACKGROUND

Field

The present disclosure relates to an indoor positioning system and method having improved accuracy. More particularly, the present disclosure relates to an indoor positioning system and method able to significantly improve the accuracy of indoor positioning by measuring an indoor position using radiofrequency (RF) signals output from RF transmitters (e.g. a beacon) and by using position information measured by pedestrian dead reckoning (PDR) using sensing information obtained by sensing the movement of a user terminal. In addition, in a case of measuring an indoor position using an RF transmitter, an error in the signal strength of an RF signal received by a user terminal through a variety of objects (e.g. walls and doors) in an indoor space can be corrected using spatial information regarding the indoor space and position information regarding the RF transmitter and a movement area allowed for a user (a user is allowed to be in the area) can be predetermined using the spatial information, so that the indoor position can be more precisely and accurately measured.

Description of Related Art

Location based services (LBSs), providing information based on the location of a user by determining a position of a user terminal, such as a mobile phone, are widely used. LBSs can determine positions of user terminals using global positioning system (GPS) receivers. In the case of GPS receivers, there are many cases in which it is difficult to receive GPS satellite signals in indoor spaces. Thus, it is difficult to provide continuous indoor position information to users.

Various indoor positioning technologies for solving these problems are known. For example, a plurality of access points (APs) may be installed in indoor spaces, such as the internal spaces of buildings, and the positions of user terminals may be determined through radiofrequency (RF) signals. Alternatively, the positions of user terminals may be determined using infrared (IR) radiation or ultrasonic waves, as well as RF signals.

However, such conventional indoor positioning technologies are disadvantageously impractical for use indoors, because measurement errors thereof may be in the range of several meters, while system installation costs may be relatively high.

In addition, in such a wireless network, the strength of an RF signal may change while passing through an object (e.g. a wall or a door), depending on the shapes or characteristics of indoor spaces. Such a change in signal strength may lead to a distortion in the determined position of a user terminal receiving an RF signal, thereby preventing the position of a user from being accurately determined.

Pedestrian dead reckoning (PDR) for estimating the position of a pedestrian, rather than a vehicle, is well known. PDR determines the position of a pedestrian by performing a variety of processes, e.g. measurement of the number of steps of the pedestrian, estimation of the length of steps of the pedestrian, and estimation of the direction of the pedestrian, using sensors, such as an accelerometer, a gyroscope, and a barometer. An example of PDR is illustrated in FIG. 1.

FIG. 1A and FIG. 1B illustrate examples of pedestrian position estimation based on PDR.

First, FIG. 1A illustrates an example in which errors have accumulated without being corrected when positioning a pedestrian (i.e. a user) using PDR, while FIG. 1B illustrates the positions of the user measured after the errors have been corrected.

In general, PDR has errors in the range of 12 meters to 15 meters per 100 meters, while relatively-accurate positions can be measured in the range of, for example, 10 meters. Thus, the range of applications of PDR is increasing. However, more errors in PDR may accumulate as the user moves for a longer period of time, so that measured positions may significantly differ from actual positions. Since PDR measures the relative position of a user depending on the movement of a user terminal from a specific point, an initial position (first fix) cannot be specified. Thus, PDR is a technology that is difficult to be used alone. In this regard, a technical solution of measuring the current position of a user by measuring the absolute position of the user using APs marked with small circles and correcting errors in the PDR-based position using the absolute position is known in the art.

In a case of measuring an indoor position using PDR, it may be essential to accurately specify the initial position of the user of which an error is to be corrected.

However, in a case of typical indoor positioning using a wireless network as described above, it may be difficult to accurately specify an initial position, since a variety of objects located in the indoor space may change the signal strength of an RF signal.

In recent years, a range of beacon-based services have come to prominence. Beacons are RF transmitters able to output RF signals at specific frequencies. Specifically, beacons can output low-frequency RF signals using a protocol based on Bluetooth 4.0 (BLE: Bluetooth Low Energy). Beacons can support high speed wireless communication while consuming small amounts of power. In addition, the Bluetooth chipset of each beacon may have unique identification information (i.e. unique ID information identifying each device, for example, Universally Unique IDentifier (UUID), Major Value, Minor Value, or media access control (MAC) addresses). Beacons can be identified based on unique ID information, even in a case that pairing is not performed between devices. Beacons can exchange information with user terminals in real time. Due to such advantages, the applications of beacons are rapidly expanding.

However, in the past, services using beacons for commercial purposes have been mostly provided. As an example of the use of beacons for the commercial purposes, contents (e.g. advertisement, coupons, or the like) corresponding to identification information of a specific RF transmitter (beacon) are provided to a user terminal receiving an RF signal from the specific RF transmitter (or beacon).

In addition, positioning in indoor spaces is generally performed using APs of a wireless network, such as Wi-Fi, as described above. The use of RF transmitters, such as beacons, may reduce costs required for the construction of an indoor positioning system, thereby improving the efficiency of indoor positioning.

Therefore, there is demand for a technical solution able to construct a simple and inexpensive wireless network system using RF transmitters, such as beacons, and correct the position of a moving user measured using PDR, which can easily determine the position of the user, using position information obtained using the wireless network system, thereby more accurately determining the position of the user in an indoor space.

In addition, there is demand for an improved concept able to more accurately measure the absolute position of a user by correcting an error (that is, a change (attenuation) of signal strength) occurring when an RF signal received by a user terminal (that is, an RF signal output from an RF transmitter) passes through various objects (e.g. walls and doors) located indoors using spatial information (in particular, positions/characteristics of the objects) of the space in which the RF transmitter is installed and information of the position in which the RF transmitter is installed.

Furthermore, there is demand for a technical solution able to easily correct an abnormal position measurement, caused by fluctuations (or sparkling) of an RF signal or an error in PDR, by predetermining an area of a space in which a user can move by actively using spatial information.

### SUMMARY

Various aspects of the present disclosure are intended to simply and inexpensively construct a wireless network system using radiofrequency (RF) transmitters, such as beacons, and correct a position of a user measured by pedestrian dead reckoning (PDR) able to easily measure the position of the moving user using position information obtained using the wireless network system, so that the position of the user in an indoor space can be more accurately measured.

An aspect of the present disclosure to correct an error occurring when an RF signal received by a user terminal (i.e. an RF signal output from an RF transmitter) passes through a variety of indoors objects (e.g. walls and doors), i.e. a variation (e.g. an attenuation) in the strength of the signal, using spatial information regarding the space in which RF transmitters are disposed (i.e. the positions/characteristics of the objects) and position information regarding the RF transmitters, so that the absolute position of the user can be more accurately measured.

Another aspect of the present disclosure is to preset a movement area in the space, in which the user can move, by actively using the spatial information, so that an abnormal position measurement, caused by fluctuations (or sparkling) of an RF signal or an error in PDR, can be easily corrected.

According to an aspect, an indoor positioning system having improved accuracy may include: a database storing spatial information corresponding to a predetermined space and position information of a plurality of radiofrequency transmitters disposed in the space; a communications module receiving one or more pieces of measurement information from a user terminal that has received radiofrequency signals output from the plurality of radiofrequency transmitters, the measurement information including identification information of the plurality of radiofrequency transmitters included in the radiofrequency signals and signal strength information of the radiofrequency signals, and sensing information obtained by measuring a movement of the user terminal; a first position measurement module, when an object is determined to be present between the user terminal and the plurality of radiofrequency transmitters in the space based on the spatial information, the position information, and the measurement information, the first position measurement module correcting the signal strength information and measuring a first position of the user terminal based on the corrected signal strength information; a second position measurement module measuring a second position of the user terminal using pedestrian dead reckoning based on the sensing information; and a control module measuring a current position of the user terminal by specifying the first position measured by the first position measurement module as an initial position and updating the second position using the specified initial position.

When the pieces of measurement information are received by a number equal to or smaller than a predetermined number, the first position measurement module may measure a position of a specific radiofrequency transmitter among the plurality of radiofrequency transmitters as the first position, the signal strength information of the specific radiofrequency transmitter included in the received measurement information being equal to or higher than a predetermined strength or corresponding to highest signal strength information.

In addition, when a change per unit time in the first position measured by the first position measurement module is equal to or greater than a predetermined range, the control module may correct the current position using the second position measured by the second position measurement module.

Furthermore, the control module may set a movement area in the space using the spatial information, such that a user is allowed to move in the movement area, and corrects the current position of the user terminal based on the movement area.

In addition, the database may further store characteristics of the object located in the space and correction data according to the characteristics of the object located in the space, the correction data being based on variations in strength of the radiofrequency signals passing through the object.

Furthermore, the first position measurement module may recognize the object located in a path, along which a radiofrequency signal among the radiofrequency signals is received by the user terminal, using the spatial information and correct the signal strength information based on the correction data corresponding to the characteristics of the recognized object.

In addition, when the user terminal receives a plurality of radiofrequency signals, the first position measurement module may estimate candidate positions according to the plurality of radiofrequency signals received by the user terminal, and when an overlapping common position exists among the candidate positions of the plurality of radiofrequency signals, the first position measurement module measures the common position as the first position of the user terminal.

Furthermore, the first position measurement module may recognize the object located at a distance from a radiofrequency transmitter among the plurality of received radiofrequency signals that outputs the specific radiofrequency signal, the distance being equal to or smaller than a distance corresponding to a signal strength of a specific radiofrequency signal, and estimate a candidate position corresponding to the specific radiofrequency signal based on the signal strength corrected using correction data corresponding to the recognized object.

In addition, the control module may change at least one period of a period of time for which the initial position is specified and a period of time for which the first position measurement module measures the first position to be different, depending on at least one of factors determined by the first position measurement module. The factors may include presence or absence of the object between the user terminal and the plurality of radiofrequency transmitters determined by the first position measurement module, the number of the objects located in the path, and characteristics of the objects.

According to another aspect, an indoor positioning method may include: storing, by an indoor positioning system having improved accuracy, spatial information corresponding to a predetermined space and position information regarding a plurality of radiofrequency transmitters disposed in the space; receiving, by the indoor positioning system, one or more pieces of measurement information from a user terminal that has received radiofrequency signals output from the plurality of radiofrequency transmitters, the measurement information including identification information of the plurality of radiofrequency transmitters included in the radiofrequency signals and signal strength information of the radiofrequency signals, and sensing information obtained by measuring a movement of the user terminal; when an object is determined to be present between the user terminal and the plurality of radiofrequency transmitters in the space based on the spatial information, the position information, and the measurement information, correcting, by the indoor positioning system, the signal strength information and measuring a first position of the user terminal based on the corrected signal strength information; measuring, by the indoor positioning system, a second position of the user terminal using pedestrian dead reckoning based on the sensing information; and measuring, by the indoor positioning system, a current position of the user terminal by specifying the first position measured by the first position measurement module as an initial position and updating the second position using the specified initial position.

In addition, in the process of receiving the one or more pieces of measurement information from the user terminal that has received the radiofrequency signals output from the plurality of radiofrequency transmitters, when the pieces of measurement information are received by a number equal to or smaller than a predetermined number, the indoor positioning system may measure a position of a specific radiofrequency transmitter among the plurality of radiofrequency transmitters as the first position, the signal strength information of the specific radiofrequency transmitter included in the received measurement information being equal to or higher than a predetermined strength or corresponding to highest signal strength information.

Furthermore, in the process of measuring the current position of the user terminal by specifying the first position measured by the first position measurement module as the initial position and updating the second position using the specified initial position, when a change per unit time in the first position measured by the first position measurement module is equal to or greater than a predetermined range, the indoor positioning system may correct the current position using the second position measured by the second position measurement module.

In addition, the indoor positioning method may further include: setting, by the indoor positioning system, a movement area in the space, such that a user is allowed to move in the movement area; and correcting, by the indoor positioning system, the current position of the user terminal based on the movement areas.

Furthermore, in the process of storing the spatial information corresponding to the space and the position information of the plurality of radiofrequency transmitters disposed in the space, the indoor positioning system may store characteristics of the object located in the space and correction data according to the characteristics of the object located in the space, the correction data being based on variations in strength of the radiofrequency signals passing through the object.

In addition, in the process of correcting the signal strength information and measuring the first position of the user terminal based on the corrected signal strength information, the indoor positioning system may recognize the object located in a path, along which a radiofrequency signal among the radiofrequency signals is received by the user terminal, using the spatial information and corrects the signal strength information based on the correction data corresponding to the characteristics of the recognized object.

Furthermore, in the process of measuring the current position of the user terminal by specifying the first position measured by the first position measurement module as the initial position and updating the second position using the specified initial position, the indoor positioning system may change at least one period of a period of time for which the initial position is specified and a period of time for which the first position measurement module measures the first position to be different, depending on at least one of factors determined by the first position measurement module. The factors may include presence or absence of the object between the user terminal and the radiofrequency transmitter, the number of the objects located in the path, and characteristics of the objects.

According to a further aspect, a computer program may be recorded in a recording medium disposed in a data processor to carry out the above-described method.

According to the present disclosure, the wireless network system using RF transmitters, such as beacons, is constructed, and a current position of a user is measured using the wireless network system, as well as a position of the user measured by pedestrian dead reckoning (PDR) able to easily measure the position of the moving user using position information obtained using the wireless network system. It is thereby possible to comprehensively correct an error, such as an abnormal position measurement, caused by accumulative errors in PDR and fluctuations (or sparkling) of the RF signal, so that the accuracy of the positioning of the user in an indoor space can be significantly improved.

In particular, an error occurring when an RF signal received by a user terminal (i.e. an RF signal output from an RF transmitter) passes through a variety of indoor objects (e.g. walls and doors), i.e. a variation (e.g. an attenuation in the strength of the signal, can be corrected using spatial information regarding the space in which RF transmitters are disposed (i.e. the positions/characteristics of the objects) and position information regarding the RF transmitters, so that the absolute position of the user can be more accurately measured.

In addition, a movement area in the space, in which the user can move, can be preset by actively using the spatial information, so that an abnormal position measurement, caused by fluctuations (or sparkling) of an RF signal or an error in PDR, can be easily corrected.

### BRIEF DESCRIPTION OF THE DRAWINGS

A brief description is given for better understanding of the accompanying drawings, in which:

FIG. 1A and FIG. 1B illustrate examples of pedestrian position estimation based on PDR;

FIG. 2 illustrates an example in which an indoor positioning system having improved accuracy according to an embodiment measures a first position of a user terminal in an indoor space;

FIG. 3 illustrates an example in which an RF signal passes through an object located in a space in the indoor positioning system having improved accuracy according to embodiments;

FIG. 4 illustrates a schematic configuration of an indoor positioning system having improved accuracy according to an embodiment;

FIG. 5 illustrates an example of a method of correcting signal strength information of an RF signal in the indoor positioning system having improved accuracy according to an embodiment;

FIG. 6 illustrates an example of a method of measuring a first position of a user terminal in the indoor positioning system having improved accuracy according to an embodiment;

FIG. 7 illustrates an example in which the indoor positioning system having improved accuracy according to embodiments sets movement areas using spatial information; and

FIG. 8 is a schematic flowchart illustrating the indoor positioning method having improved accuracy according to embodiments.

### DETAILED DESCRIPTION

Advantages of the present disclosure associated with operations and objects that may be realized by the practice of the present disclosure will be apparent with reference to the accompanying drawings illustrating embodiments of the present disclosure and from the following description of the accompanying drawings.

According to an aspect of the present application, a method of providing wireless signal intensity data is disclosed. In embodiments, the method comprises providing 3D model data of a building that has a plurality of interior structures and objects, wherein the 3D model data comprise a location and a material for at least part of the plurality of interior structures and objects. In embodiments, the 3D model data comprise permeability data indicative of permeability of wireless signals in a radial direction from a point of the first wireless transmitter at a three-dimensional location within the building, wherein the permeability at three-dimensional location is dependent on spatial occupancy and material of a structure or object at the three-dimensional location. In embodiments, a signal intensity data representing a spatial map of intensity of wireless signals transmitted from a wireless transmitter is obtained by processing the permeability data. In embodiments, in the spatial map equiintensity lines for the first wireless transmitter are not concentric and comprise at least one discontinuous point due to spatial occupancy of at least part of the plurality of interior structures and objects.

In embodiments, the method further comprises generating first signal intensity data representing a first spatial map of wireless signal intensity for a first wireless transmitter installed or to be installed inside the building using the 3D model data, a first location of the first wireless transmitter and a first signal strength of the first wireless transmitter, wherein at a first three-dimensional location wireless signal intensity from the first wireless transmitter is computed in consideration of attenuation of wireless signal intensity depending on spatial occupancy and a material of at least one structure or object located between the first wireless transmitter and the first three-dimensional location, wherein equiintensity lines of the first spatial map are not concentric and comprise at least one discontinuous point due to spatial occupancy of at least part of the plurality of interior structures and objects. In embodiment, the method further comprises: generating second signal intensity data representing a second spatial map of wireless signal intensity for a second wireless transmitter installed or to be installed inside the building using the 3D model data, a second location of the second wireless transmitter and a second signal strength of the second wireless transmitter, wherein at a second three-dimensional location wireless signal intensity from the second wireless transmitter is computed in consideration of attenuation of wireless signal intensity depending on spatial occupancy and a material of at least one structure or object located between the second wireless transmitter and the second three-dimensional location, wherein equiintensity lines of the second spatial map are not concentric and comprise at least one discontinuous point due to spatial occupancy of at least part of the plurality of interior structures and objects.

In embodiments, the method further comprises: generating third signal intensity data representing a third spatial map of wireless signal intensity for of a third wireless transmitter installed or to be installed inside the building using the 3D model data, a third location of the third wireless transmitter and a third signal strength of the third wireless transmitter, wherein at a third three-dimensional location wireless signal intensity from the third wireless transmitter is computed in consideration of attenuation of wireless signal intensity depending on spatial occupancy and a material of at least one structure or object located between the third wireless transmitter and the third three-dimensional location, wherein equiintensity lines of the third spatial map are not concentric and comprise at least one discontinuous point due to spatial occupancy of at least part of the plurality of interior structures and objects.

In the foregoing method, the term “equiintensity line” for a wireless transmitter represents a line formed by points on a plane passing the wireless transmitter that have the same intensity of wireless signals from the wireless transmitter and includes at least one discontinuous point due to spatial occupancy of one or more interior structures and objects inside a building. Given the three-dimensional nature of wireless signal transmission, multiple equiintensity lines can be drawn on different planes for the same signal intensity.

In the foregoing method, the spatial occupancy may be represented by location, shape, size of an interior structure or object. Providing permeability data may comprise empirical testing of wireless signal intensity at three-dimensional locations inside the building and may further comprise mathematical modeling of wireless signal intensity using spatial occupancy and materials of at least part of the plurality of interior structures and objects. The mathematical modeling may further use data collected from the empirical testing.

Another aspect of the invention provides a method of indoor location information services. The method comprises: performing the foregoing method to provide the first, second and third signal intensity data, in which equiintensity lines comprise a plurality of discontinuous points due to spatial occupancy of at least part of the plurality of interior structures and objects; receiving, from a mobile terminal, a location information request comprising identification of the first wireless transmitter and a first intensity of signals from the first wireless transmitter at a location, identification of the second wireless transmitter and a second intensity of signals from the second wireless transmitter at the location, and identification of the third wireless transmitter and a third intensity of signals from the third wireless transmitter at the location; determining coordinates of the location using the first, second and third intensity and the first, second and third signal intensity data; and sending the coordinates of the location to the mobile terminal.

In embodiments, coordinates determined using the first, second and third intensity and the first, second and third signal intensity data is verified in view of 3D model of the building. The 3D model comprises information of locations where a mobile terminal may not be present (locations allowed for a user to enter), and when a coordinate determined based on the wireless signal intensity map is at a wall of the building where a mobile terminal cannot present, it may indicate a potential error of positioning. In embodiments, when a path connecting a current coordinate determined using the wireless signal intensity map and a previous coordinate determined using the wireless signal intensity map (the immediately precedent coordinate determined by the first position measurement module 130) crosses an impassable structure (structural wall) of the building, it also may indicate a potential error of positioning. In response to such error, a process for adjusting current coordinate of the mobile terminal is initiated.

In embodiments, coordinates of the mobile terminal inside building are determined periodically, repeatedly with a time interval using the first, second and third intensity and the first, second and third signal intensity data is verified in view of 3D model of the building by the first position measurement module 130. During the time interval of coordinate determination by the first position measurement module 130 (after the first position measurement module determines a first coordinate and before the first position measurement module determines a second coordinate), second position measurement module 140 can update the coordinate using pedestrian dead reckoning (PDR), from the first coordinate determined by the first position measurement module, using information representing movement of the mobile terminal (data from sensors of the mobile terminal). Subsequently, when the second coordinate is determined by the first position measurement module, the second position measurement module 140 starts to update the mobile terminal's coordinate from the second coordinate (new starting coordinate for updating using PDR).

Another aspect of the invention provides a system for indoor location information services. The system comprises: data store comprising first signal intensity data representing a spatial map inside a building of intensity of wireless signals transmitted from a first wireless transmitter, second signal intensity data representing a spatial map inside the building of intensity of wireless signals transmitted from a second wireless transmitter, and third signal intensity data representing a spatial map inside the building of intensity of wireless signals transmitted from a third wireless transmitter; at least one computing device configured: to receive, from a mobile terminal, a location information request comprising identification of the first wireless transmitter and a first intensity of signals from the first wireless transmitter at a location, identification of the second wireless transmitter and a second intensity of signals from the second wireless transmitter at the location, and identification of the third wireless transmitter and a third intensity of signals from the third wireless transmitter at the location, to determine coordinates of the location using the first, second and third intensity and the first, second and third signal intensity data; and to send the coordinates of the location to the mobile terminal.

A further aspect of the invention provides a method of indoor location information services. The method comprises: providing the foregoing system; receiving, from a mobile terminal, a location information request comprising identification of the first wireless transmitter and a first intensity of signals from the first wireless transmitter at a location, identification of the second wireless transmitter and a second intensity of signals from the second wireless transmitter at the location, and identification of the third wireless transmitter and a third intensity of signals from the third wireless transmitter at the location; determining coordinates of the location using the first, second and third intensity and the first, second and third signal intensity data; and sending the coordinates of the location to the mobile terminal.

Herein, it will be understood that, when an element is referred to as “transmitting” data to another element, the element can not only directly transmit data to another element but also indirectly transmit data to another element via at least one intervening element.

In contrast, when an element is referred to as “directly transmitting” data to another element, the element can transmit the data to another element without an intervening element.

Herein, the term “first position” may refer to the position of a user terminal measured by an indoor positioning system having improved accuracy using a radiofrequency (RF) transmitter. The first position may mean the absolute position of the user terminal, resultantly measured in an indoor space.

In addition, the term “second position” used herein may refer to the position of the user terminal measured using the pedestrian dead reckoning (PDR), described above in the background section, using sensing information (e.g. the number, length, and direction of steps of a user) obtained using a variety of sensors disposed on the user terminal. In this case, the second position may be a relative position, depending on the movement of the user terminal from a specific point.

The position of the user terminal finally measured using the first position and the second position will be defined as the current position according to the concept of the present disclosure, to be described later in the specification.

Hereinafter, embodiments will now be described more fully with reference to the accompanying drawings. The same reference numerals and signs are used throughout the different drawings to designate the same components.

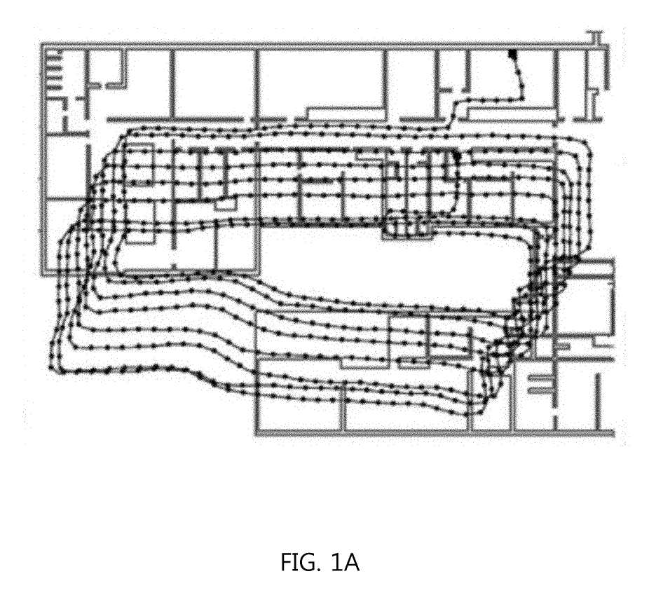

First, a method of more accurately measuring a first position of a user terminal carried by a user using a plurality of RF transmitters disposed in a predetermined indoor space will be described in detail. As will be described later, the first position of the user terminal that has been measured as described above may be regarded as the current position of the user terminal. However, according to the concept of the present disclosure, the first position may be used as an initial position to correct a second position of the user terminal that has been measured by the PDR-based positioning method as described above with reference to FIG. 1. Since a PDR-based positioning method measures a relative position based on the movement of the user terminal, an initial position cannot be determined when the PDR-based positioning method is used alone. It is therefore difficult to accurately measure a position, which is problematic. Accordingly, the present disclosure can correct errors in PDR using a first position, measured using the RF transmitters, as the initial position. Here, the present disclosure can also improve the accuracy of positioning of the first position using spatial information, thereby significantly improving the accuracy of indoor positioning.

Alternatively, the second position measured using PDR can be used as auxiliary information in the first position, measured by triangulation using RF signals output from the RF transmitters, thereby more accurately measuring the current position. In any cases, according to the technical concept of the present disclosure, a measuring method using RF transmitters and a measuring method using PDR are combined to compensate for drawbacks thereof, so that an indoor position can be more accurately measured.

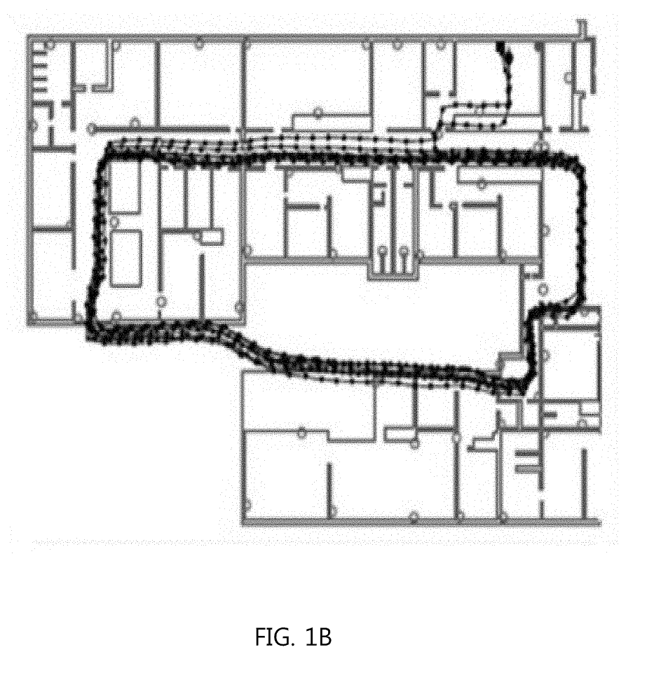

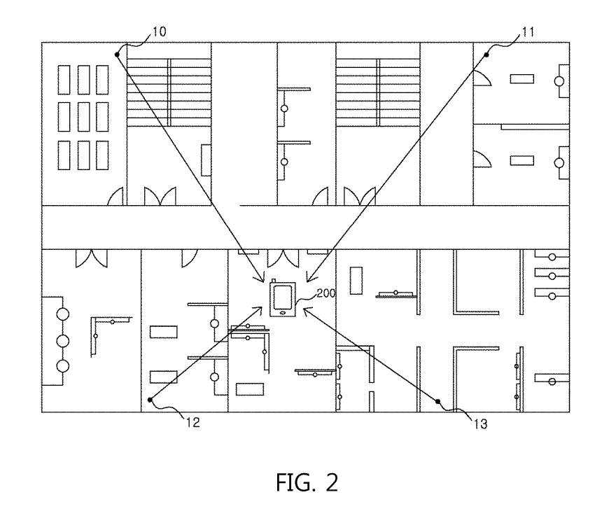

As described above, in the measurement of the first position using the RF transmitters, the correction of errors due to variations in the strength of RF signals caused by a variety of objects (e.g. walls and doors) located in the indoor space may be key factors for measuring a more accurate position. An example thereof will be described with reference to FIG. 2 and FIG. 3.

FIG. 2 illustrates an example in which an indoor positioning system having improved accuracy according to an embodiment measures a first position of a user terminal in an indoor space, while FIG. 3 illustrates an example in which an RF signal passes through an object located in a space in the indoor positioning system having improved accuracy according to embodiments.

Referring to FIG. 2, a plurality of RF transmitters, e.g. 10, 11, 12, and 13, are disposed in predetermined positions in an indoor space. A user is located in a predetermined position within the space while carrying a user terminal 200.

Each of the plurality of RF transmitters 10, 11, 12, and 13 may be implemented as beacons as described above, but the scope of the present disclosure is not limited thereto. Any device may be used herein as long as the device is able to output an RF signal including identification information thereof.

Then, the user terminal 200 can receive an RF signal output from at least one of the plurality of RF transmitters 10, 11, 12, and 13. It is obvious that the user terminal 200 can receive RF signals output from the entirety of the plurality of RF transmitters 10, 11, 12, and 13. In a case that the user terminal 200 receives a plurality of RF signals output as described above, all of the plurality of RF signals may be used for positioning the user terminal 200. However, according to implementations, specific RF signals (e.g. three RF signals) among the plurality of RF signals received by the user terminal 200 may be used for positioning the user terminal 200. Although the specific RF signals may be randomly determined from among the plurality of radio signals, it is preferable that the specific RF signals (e.g. three RF signals) having higher levels of strength are preferentially determined from among the plurality of radio signals received by the user terminal 200 in order to improve the accuracy of positioning. In addition, the position of the user terminal 200 measured using RF signals output from the plurality of RF transmitters, e.g. 10, 11, 12, and 13, may be defined as the first position as described above.

As described above, each of the RF signals may include identification information of the RF transmitter corresponding thereto. Then, the user terminal 200 may obtain the identification information, as well as measurement information including signal strength information of the received RF signal, from the RF signal. The obtained measurement information is transmitted to the indoor positioning system 100 with improved accuracy, and the first position of the user terminal 200 can be measured.

In this regard, spatial information corresponding to the indoor space and position information regarding positions in which the plurality of RF transmitters, e.g. 10, 11, 12, and 13, are disposed may be pre-stored in the indoor positioning system 100 having improved accuracy, as will be described later. In this case, it is possible to determine a specific RF transmitter among the plurality of RF transmitters, from which the user terminal 200 has received the RF signal, based on the identification information. In addition, the position of the RF transmitter (or an area within a predetermined range from the RF transmitter) corresponding to the identification information is measured as the first position of the user terminal 200. The predetermined range may be determined by the signal strength information of the RF signal received by the user terminal 200.

A positioning method or algorithm, such as triangulation, of determining a position by receiving a plurality of RF signals may be well-known in the art, and detailed descriptions thereof will be omitted herein. Herein, for the sake of brevity, by way of example, a case in which the first position of the user terminal 200 is measured by triangulation when a plurality of RF signals are received by the user terminal 200 will be discussed, but the scope of the present disclosure is not limited thereto.

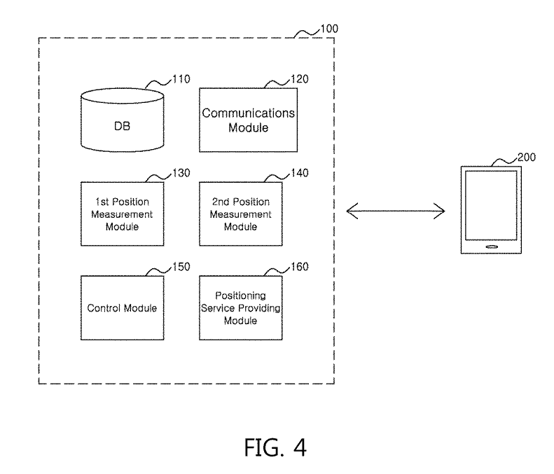

In this case, as illustrated in the drawings, there may be many cases in which the RF signal passes through various objects, such as walls and doors, rather than directly arriving at the user terminal 200. In general, a distance between the user terminal 200 and the RF transmitter outputting the RF signal may be calculated from the signal strength information of the corresponding RF signal. However, as illustrated in FIG. 5 to be described below, the signal strength of the RF signal may be distorted while passing through the objects. Thus, an error may occur between the actual position of the user terminal 200 and the measured position.

Therefore, the indoor positioning system 100 having improved accuracy according to embodiments may be implemented to have spatial information of the space and position information of the plurality of RF transmitters 10, 11, 12, and 13 pre-stored therein, and based on such information, correct the signal strength information of an RF signal.

At this time, the spatial information may be formed by, for example, building information modeling (BIM), but is not limited thereto. The spatial information may be information that is modeled to express objects (e.g. floors or walls) that may be located in the path of an RF signal (or express the positions of the objects), even if the spatial information may not express information on all objects included in the internal space of a building (e.g. facilities, such as electric wirings or water pipes, or inner objects, such as desks or chairs).

The spatial information may further include information on the characteristics of the objects. The characteristics of the objects may be information on the characteristics of the objects, such as the thicknesses, materials, or the like of the objects, which may influence the signal strength of an RF signal when the RF signal passes through the objects. For example, when an RF signal passes through a wall, the attenuation degree of the RF signal may vary according to the thickness or the material of the wall, for example, according to whether the material of the wall is concrete, wood, or glass. Thus, a more accurate position of the user terminal 200 may be measured by correcting the signal strength information of the RF signal received by the user terminal 200 using the spatial information, the characteristics of the objects, and a variation in the signal strength of the RF signal passing through the wall according to the characteristics of the objects.

For example, as illustrated in FIG. 3, in a case in which the user terminal 200 receives RF signals (e.g. a first RF signal, a second RF signal, and/or a third RF signal) from the first RF transmitter 10, the second RF transmitter 11, and the third RF transmitter 12, the user terminal 200 may transmit the identification information of the RF transmitters obtained from the RF signals and measurement information including the signal strength information of the RF signals (e.g. the first RF signal, the second RF signal, and/or the third RF signal) to the indoor positioning system 100 having improved accuracy.

Then, the indoor positioning system 100 having improved accuracy is able to calculate the position of the user terminal 200 based on the received measurement information.

In this regard, the indoor positioning system 100 having improved accuracy can correct the distance or the signal strength between the user terminal 200 and each of the RF transmitters.

That is, it can be understood that an RF signal (e.g. a first RF signal) output from the first RF transmitter 10 can arrive at the user terminal 200 through a wall 1, while an RF signal (e.g. a second RF signal) output from the second RF transmitter 20 can arrive at the user terminal 200 through a wall 2. In addition, an RF signal (e.g. a third RF signal) output from the third RF transmitter 12, located in the same sub-space as the user terminal 200, can directly arrive at the user terminal 200 without passing through any object.

At this time, the indoor positioning system 100 having improved accuracy can correct the signal strength information included in the first received measurement information, according to the characteristics of the wall 1, i.e. the material (e.g. concrete, plaster, wood, or the like) and the thickness of the wall 1. Based on the corrected signal strength information, the indoor positioning system 100 can calculate the distance between the first RF transmitter 10 and the user terminal 200. Similarly, the signal strength information of the RF signal passing through the wall 2 may be corrected according to the characteristics of the wall 2, and the distance between the second RF transmitter 11 and the user terminal 200 may be calculated using the corrected signal strength information. In the case of the third RF transmitter 12, no correction may be performed because the pre-stored spatial information indicates that no objects are located between the third RF transmitter 12 and the user terminal 200.

When the signal strength information on the RF signals received by the user terminal 200 is corrected according to the characteristics of the objects as described above, it is possible to measure a relatively accurate position of the user terminal 200 in the space using the corrected signal strength information.

To determine whether a predetermined object is located between each of the RF transmitters 10, 11, and 12 and the user terminal 200, it is necessary to determine the position of the user terminal 200. In this regard, according to an embodiment, the position of the user terminal 200 may be roughly determined based on the signal strength information of the respective RF signals included in the measurement information initially received from the user terminal 200, and objects existing between the RF transmitters 10, 11, and 12 and the user terminal 200 may be determined using the roughly-determined position of the user terminal 200. However, in this case, there is a problem in that the presence or absence of an object is determined based on the inaccurate position of the user terminal 200.

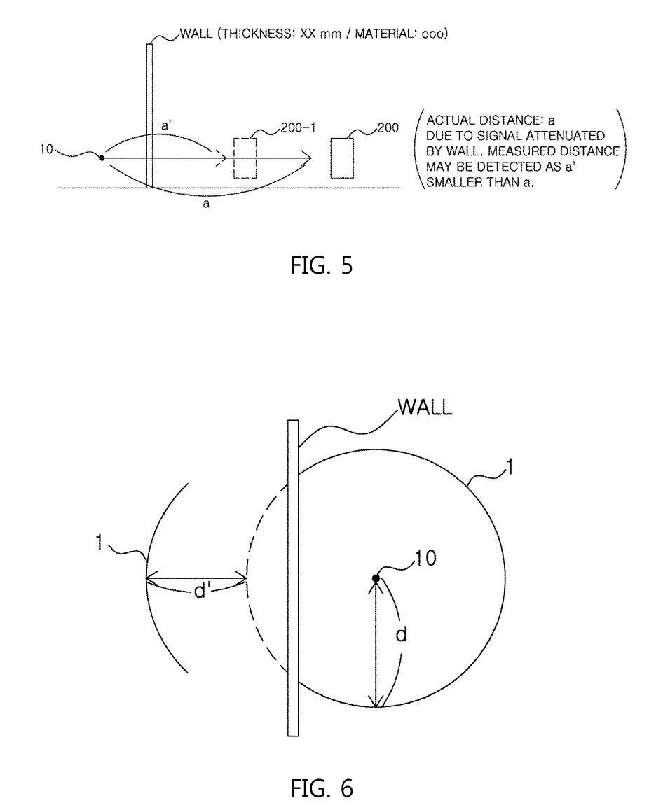

Therefore, another embodiment may provide an inventive concept of estimating candidate positions of the user terminal 200, based on the RF transmitters 10, 11, and 12, and measuring the position of the user terminal 200 using the estimated candidate positions. A method of estimating candidate positions of the user terminal 200 in the indoor positioning system 100 having improved accuracy will be described with reference to FIG. 6.

FIG. 6 illustrates an example of a method of measuring a first position of a user terminal in the indoor positioning system having improved accuracy according to an embodiment.

Referring to FIG. 6, the position of the user terminal 200 receiving an RF signal (e.g. a first RF signal) output from a specific RF transmitter (e.g. the first RF transmitter among the plurality of RF transmitters 10, 11, 12, and 13) may be in a range defined by a predetermined radius (e.g. d) from the first RF transmitter 10, i.e. the center. The predetermined radius d may be determined based on the signal strength information of the first RF signal received by the user terminal 200.

At this time, in a case in which an object (e.g. a wall) does not exist between the first RF signal and the user terminal 200 receiving the first RF signal, the user terminal 200 receiving the first RF signal can be estimated as being located on a circumference of a circle having the radius d. In this case, the distance between the first RF transmitter and the user terminal 200 can be calculated based on the signal strength of the first RF signal received by the user terminal 200 as described above. Accordingly, the indoor positioning system 100 having improved accuracy can estimate a position in which the user terminal 200 may be located, i.e. the circumference of the circle having the radius d from the first RF transmitter 10, i.e. the center, as a candidate position 1 of the user terminal 200.

As illustrated in FIG. 6, in a case in which a predetermined object (e.g. a wall) exists in the path of the first RF signal (i.e., within the radius d), the signal strength of the first RF signal may be distorted when the first RF signal passes through the object (e.g. the wall). In this case, when the user terminal 200 is located beyond the object (e.g. a wall, for example, on the left side of the drawing), an actual position must inevitably be different from a measured position even in the case in which an RF signal having the same signal strength as the right side of the object (e.g. a wall) is received.

Therefore, as described above, the indoor positioning system 100 having improved accuracy can estimate the candidate position 1 (indicated by a solid line) of the user terminal 200 by correcting the signal strength of the first RF signal in a portion (indicated by a dashed line) in which the first RF signal passes through the object (e.g. the wall) using the pre-stored spatial information of the space and the position information of the RF transmitters. That is, in a case in which the signal strength is not corrected, the circumference of the circle having the radius d from the first RF transmitter 10, i.e. the center, may be estimated as the candidate position. However, according to the concept of the present disclosure, in the portion in which the user terminal 200 passes through the object (e.g. the wall), a position spaced apart from the first RF transmitter 10 by a distance d+d′ can be estimated as the candidate position.

The indoor positioning system 100 having improved accuracy may estimate all or portions of positions in which the user terminal 200 can be estimated to be located (i.e., positions in which the user terminal 200 can receive the first RF signal having the corresponding signal strength) as candidate positions, according to the output radius based on the signal strength of the first RF signal.

For example, the indoor positioning system 100 having improved accuracy may determine positions among the candidate positions, except for positions in which the user cannot be located in the space, based on the pre-stored spatial information, and estimate the determined positions as first candidate positions of the first RF transmitter 10.

As a result, as illustrated in FIG. 6, in a case in which the signal strength of the RF signal (e.g. the first RF signal) received from the first RF transmitter 10 is a level of signal strength corresponding to the distance d, the indoor positioning system 100 having improved accuracy can determine an object existing in the position of the distance d from the first RF transmitter 10. Then, the candidate position can be determined using the signal strength that is corrected using correction data according to the determined object.

As described above, the method of estimating the candidate position of the user terminal 200 in the indoor positioning system 100 having improved accuracy may be equally applied to RF signals even in a case in which the user terminal 200 receives plurality of RF signals from the plurality of RF transmitters.

For example, as described above, in a case in which the user terminal 200 receives the first RF signal output from the first RF transmitter 10, the second RF signal output from the second RF transmitter 11, and the third RF signal output from the third RF transmitter 12 and transmits the measurement information including the signal strength information and the identification information thereof, the indoor positioning system 100 having improved accuracy can correct the signal strength levels of the RF signals in positions, in which the RF signals from the RF transmitters (e.g. the first RF transmitter 10, the second RF transmitter 11, and/or the third RF transmitter 12) can be received, and can estimate the candidate positions according to the RF signals (i.e. according to the RF transmitters) using the corrected signal strength information.

The indoor positioning system 100 having improved accuracy can specify a commonly-overlapping candidate position among the estimated candidate positions as a common position and can measure the specified common position as a current position of the user terminal 200. At this time, as described above, a plurality of candidate positions may be estimated for each RF signal or the candidate positions may be estimated to be in a predetermined range.

In order to correct the signal strength information of the RF signal that has passed through the object, the indoor positioning system 100 having improved accuracy may have predetermined correction data pre-stored therein, the correction data indicating the degree of the variation of the signal strength of the RF signal according to the characteristics of the object. The correction data will be described below.

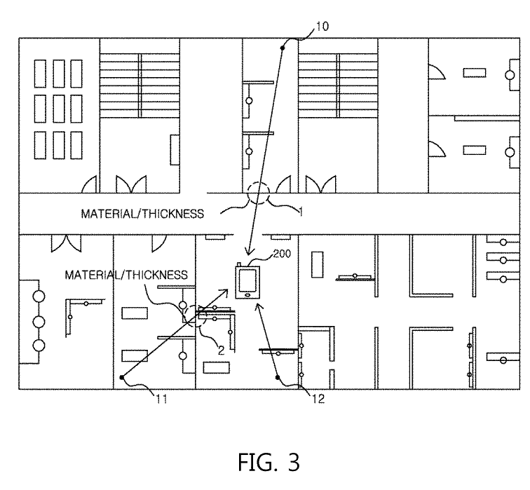

Hereinafter, the configuration, operation, and effects of the indoor positioning system 100 having improved accuracy according to the embodiments of the present application will be described with reference to FIG. 4 and FIG. 5.

FIG. 4 illustrates a schematic configuration of an indoor positioning system having improved accuracy according to an embodiment, and FIG. 5 illustrates an example of a method of correcting signal strength information of an RF signal in the indoor positioning system having improved accuracy according to an embodiment.

First, referring to FIG. 4, the indoor positioning system 100 having improved accuracy according to embodiments includes a database (DB) 110, a communications module 120, a first position measurement module 130, a second position measurement module 140, and a control module 150. According to implementations, the indoor positioning system 100 having improved accuracy may further include a positioning service providing module 160. In addition, the indoor positioning system 100 having improved accuracy may transmit and receive data necessary for realizing the inventive concept of the present disclosure while communicating with the user terminal 200.

The indoor positioning system 100 having improved accuracy may include hardware resources and/or software necessary for realizing the inventive concept of the present disclosure and may not necessarily mean a single physical element or a single apparatus. That is, the indoor positioning system 100 having improved accuracy may be a logical combination of hardware and/or software included for realizing the inventive concept of the present disclosure and, if necessary, may be configured by a set of logical elements disposed in separate apparatuses to realize the inventive concept of the present disclosure by performing their functions.

The indoor positioning system 100 having improved accuracy according to embodiments may be implemented as a server. In a case in which the indoor positioning system 100 having improved accuracy is implemented as a server, the indoor positioning system 100 having improved accuracy can realize the inventive concept by transmitting and receiving predetermined data while communicating with the user terminal 200 via a network.

In addition, the term “DB” used herein may mean a functional structural combination of software and hardware storing relevant information in respective pieces of DB. The DB may be implemented as at least one table and may further include a separate database management system (DBMS) for searching for, storing, and managing the information stored in the DB. In addition, the DB may be implemented in various forms, such as a linked-list, a tree, or a relational DB, and may include any data storage medium and a data structure able to store relevant information in the DB.

Furthermore, the user terminal 200 may be implemented as a mobile terminal, such as a smartphone or a tablet PC. In addition, the user terminal 200 may include any type of data processing devices, such as a notebook computer, able to realize the technical concept of the present disclosure. Such data processing devices can receive RF signals while being carried by the user and can be connected to a network.

In addition, the user terminal 200 may have at least one sensor to sense the movement thereof. The movement of the user terminal 200 may be any movements that would occur, for example, when the user walks while carrying the user terminal 200. For example, the at least one sensor can sense the vibration, rotation, and/or displacement of the user terminal 200 and can transmit sensing information to the communications module 110. Then, the indoor positioning system 100 having improved accuracy can obtain specific pieces of information, such as the number, length, and direction of steps of the user, from the sensing information to measure the second position using PDR.

The at least one sensor may be implemented as including an inertia sensor, such as an accelerometer, a gyroscope, or a barometer, or a geomagnetic sensor, but is not limited thereto.

As described above, the DB 110 may store the spatial information on the predetermined space (e.g. a building or the like) and the position information of the plurality of RF transmitters installed in the space. In addition, the DB 110 may further store the characteristics of the objects located in the space, and the correction data for the characteristics of the objects, based on the degree of the variation of the signal strength when the RF signal passes through the object. As described above, the characteristics of the objects may be information on the material and/or thicknesses of the objects. The characteristics of the objects may be included in the spatial information. According to implementations, the characteristics of the objects may be stored as information separate from the spatial information.

In addition, as described above, the correction data may be data associated with various parameters necessary for correcting a variation occurring when an RF signal of a specific frequency passes through an object formed of having material and/or having a specific thickness. For example, the DB 110 may store at least one table in which correction data is aligned, the correction data indicating variations in the RF signal passing through the object according to the material and thickness of the object, for example, when the material of the object is concrete, cement, or wood.

The correction data may be data recorded through tests in which the degrees of the variation of the signal strength of the RF signal passing through the objects are measured according to the materials of the objects. In addition, regarding the object of the specific material, the correction data may include subdivided data in which the degrees of the variation of the signal strength of the RF signal are recorded according to the thicknesses thereof. That is, according to embodiments, the correction data may be any type of data provided for correcting the signal strength of the RF signal, based on data actually measured through various experiments. In addition, regarding the object of the specific material, if an amount of the actually measured data increases, the degree of the variation of the signal strength may be calculated based on the actually measured data, even when the thickness of the object of the corresponding material is changed.

The communications module 120 can receive the measurement information including the identification information and the signal strength information of the RF signal from the user terminal 200 receiving the RF signal including the identification information of the RF transmitter, the RF signal being output from the RF transmitter. As described above, it is obvious that the measurement information may include identification information and signal strength information of the plurality of RF signals received by the user terminal 200, as well as identification information and signal strength information of one RF signal.

In addition, the communications module 120 can receive sensing information, obtained by sensing the movement of the user terminal 200, from the user terminal 200. In this regard, the communications module 120 may be provided with an inertia sensor and/or a geomagnetic sensor as described above. The second position measurement module 140 can measure the second position of the user terminal 200 using the sensing information received by the communications module 110. The second position may be a relative position caused by the movement of the user terminal 200 in the indoor space. For example, the second position measurement module 140 can determine the direction and distance of the movement with respect to a specific point (i.e. an initial position) using PDR, based on the sensing information, thereby measuring (or estimating) the position of the user terminal 200 after the movement (i.e. when the movement is stopped) as the second position.

Since the accuracy of the second position may be significantly influenced by the accuracy of the initial position (i.e. the first position), it is very important to more accurately measure the first position.

Thus, when the measurement information is received by the communications module 120, the first position measurement module 130 can correct the signal strength information included in the measurement information, based on the spatial information and the position information stored in the DB 110, and can measure the first position of the user terminal 200 using the corrected signal strength information.

At this time, the first position measurement module 130 can recognize the object located in the path, through which the RF signal is received by the user terminal 200, using the spatial information stored in the DB 110, and can correct the signal strength information included in the measurement information using the correction data corresponding to the characteristics of the recognized object. As described above with reference to FIG. 6, the process of recognizing the presence or absence of the object is performed according to whether the object is present in circular range having a radius defined by the distance between the RF transmitter and the user terminal 200, based on the signal strength information included in the measurement information.

When the object is determined to be present between the RF transmitter and the user terminal 200 through the above process, it is necessary to correct the signal strength information included in the measurement information.

Referring to FIG. 5, the user terminal 200 located in a predetermined space may receive an RF signal output from a specific RF transmitter (e.g. the first RF transmitter 10). Here, an actual distance between the first RF transmitter 10 and the user terminal 200 may be “a.” However, as illustrated in FIG. 5, in a case in which an object, for example, a wall, is present between the first RF transmitter and the user terminal 200, the signal strength of the RF signal output from the first RF transmitter 10 may be weakened while the first RF signal is passing through the wall. In a case in which the wall is not present, the distance to be calculated by the control module 150 has to be or be similar to the actual distance a. However, due to the wall, the distance to be calculated by the control module 150 may be a distance a′ that is shorter than the actual distance a. In this case, as illustrated in FIG. 5, there is a problem in that the resultant measured position of the user terminal 200 in the space may be measured as a position 200-1 different from the actual position. Therefore, according to the technical concept of the present disclosure, as described above, the position of the first RF transmitter 10, the spatial information of the space, the characteristics of the wall (e.g. the thickness and material of the wall), and the corresponding correction data can be pre-stored in the DB 110. When it is determined that the user terminal 200 receives the RF signal that has passed through the wall, the control module 150 may correct the signal strength information of the RF signal received from the first RF transmitter 10 by the user terminal 200, based on the pre-stored correction data and thus acquire the corrected signal strength information for measuring a more accurate position of the user terminal 200.

As described above with reference to FIG. 6, the first position measurement module 130 can estimate the candidate position of the user terminal 200 using the corrected signal strength information obtained through the above-described process. At this time, in a case in which the user terminal 200 receives a plurality of RF signals, it is possible to measure a relatively-accurate first position of the user terminal 200 in the space by estimating candidate positions of the plurality of RF signals and measuring a commonly-overlapping position among the estimated candidate positions as a current position of the user terminal 200.

In addition, the first position measurement module 130 can measure the first position in a different manner, according to the number of pieces of measurement information received from the user terminal 200 (i.e. the number of RF signals received by the user terminal 200).

In an implementation, when the number of pieces of measurement information received by the communications module 110 is equal to or smaller than a predetermined number (i.e. when a positioning method, such as triangulation, cannot be used), the first position can only be measured using measurement information corresponding to an RF signal having a highest level of signal strength. For example, a single or two pieces of measurement information may be received. In this case, a position in which an RF transmitter corresponding to the RF signal having the highest level of signal strength is disposed (or an area within a predetermined range from the RF transmitter) may be measured as the first position.

However, in a case in which the signal strength of the RF signal is excessively insignificant, the radius expected to indicate the position of the user terminal 200 may be excessively large, thereby increasing an error. Thus, only in a case in which the signal strength information of the measurement information is equal to or higher than a predetermined level of strength, the position of an RF transmitter corresponding thereto can be measured as the first position. For example, only in a case in which the signal strength can specify that the user terminal 200 is located in the range of 2 meters to 3 meters from the corresponding RF transmitter, the position of the corresponding RF transmitter (or an area within a predetermined range from the RF transmitter) can be measured as the first position.

When the signal strength information of the measurement information is equal to or higher than a predetermined level of strength, the control module 150 may measure the current position of the user terminal 200 using the second position measured by the second position measurement module 140, before the measurement information including the signal strength information equal to or higher than the predetermined level of strength is received by the communications module 110.

Alternatively, in a case in which the communications module 110 receives a plurality of pieces of measurement information, for example, three pieces of measurement information, a relatively-accurate position can be measured using triangulation.

In this case, the first position measurement module 130 can repeatedly measure and update the first position of the user terminal 200 for a predetermined period.

Here, in a case in which the communications module 110 receives four or more pieces of measurement information, the first position can be measured by specifying three pieces of measurement information having stronger signal strength information from the received four or more pieces of measurement information, and then, performing triangulation on the specified three pieces of measurement information.

Returning to FIG. 4, the control module 150 can finally measure the current position of the user terminal 200 using the first position and the second position of the user terminal 200 measured by the first position measurement module 130 and the second position measurement module 140.

Since errors in the second position, measured using PDR, accumulate over time as described above, there is a problem in that the distance between the actual position and the measured position may exponentially increase. In this case, when the initial position can be periodically specified (or updated), errors formed during PDR can be maintained at a significantly low level, so that the accuracy of positioning may be significantly improved.

Accordingly, the control module 150 can periodically specify the first position measured by the first position measurement module 130 as the initial position, and then, update the second position measured by the second position measurement module 140 using the specified initial position. The updated position can be measured as the current position of the user terminal 200. It is apparent that the initial position may vary depending on points in time that are specified due to the movement of the user.

According to implementations, the control module 150 may adaptively change a period of time for which the initial position is specified to update the second position and/or a period of time for which the first position measurement module 130 measures the first position of the user terminal 200.

For example, the first position measurement module 130 can determine whether or not an object is present between the user terminal 200 and the RF transmitter, as described above.

In this case, according to the structure of the space or the arrangement of objects, an RF signal output from the RF transmitter may pass through two or more objects before being received by the user terminal 200.

Then, the signal strength of the RF signal received by the user terminal 200 may be significantly distorted, so that the accuracy of the first position of the user terminal 200 measured by the first position measurement module 130 may be reduced, which is problematic. Consequently, the current position of the user terminal 200 measured by updating the second position by specifying the first position as the initial position may also be unreliable. The unreliable status may become more significant while the user is moving.

Even in a case in which a plurality of objects are present, an object more significantly distorting the signal strength than the other objects may be present, according to the characteristics of the objects. In this case, the current position of the user terminal 200 that is finally measured may be unreliable, as described above.

In addition, in a case in which a single object is present in the space, the measured position may be minutely different, compared to a case in which there are no objects.

Therefore, according to embodiments, the control module 150 can change the period of time for which the initial position is specified or the period of time for which the first position measurement module 130 measures the first position, depending on specific factors determined by the first position measurement module 130, including the presence or absence of objects in the path along which the RF signal is received by the user terminal 200, the number of the objects, and/or the characteristics of the objects.

For example, in a case in which a plurality of objects are located in the path along which an RF signal is received by the user terminal 200 or a strong distortion in signal strength is caused due to the characteristics of objects, the control module 150 can control the period of time for which the initial position is specified to be shorter than usual or the period of time for which the first position measurement module 130 measures the first position of the user terminal 200 to be shorter than usual.

When the period of time for which the first position is measured and/or the period of time for which the first position is specified as the initial position are caused to be shorter than usual, even in a case in which the first position measured during a specific period has an error, the first position having the error can be corrected at a faster point in time. This can consequently improve the accuracy of the current position of the user terminal 200 that is finally measured.

The RF transmitter, such as a beacon, may suffer from fluctuations (or sparkling) in the level of received signal strength indication (RSSI), which are problematic. For example, there is a problem in that the signal strength of the beacon may frequently change, rather than remaining constant, even in a hollow space in which no objects are present.

When the level of change is insignificant and does not exceed a predetermined level, it is possible to measure a relatively-accurate position without significant difficulties using triangulation or the like.

However, since fluctuations (or sparkling) in RSSI generally doubles or triples the level of RSSI in a very short time, the use of triangulation cannot prevent the measured position of the user terminal 200 from being significantly different.

Thus, in a case in which a change per unit time in the first position of the user terminal 200 measured by the first position measurement module 130 is equal to or greater than a predetermined range, for example, in a case in which the first position is significantly changed in the range of 2 meters to 3 meters or more in the space for one second, the control module 150 can correct the current position using the second position of the user terminal 200 measured by the second position measurement module 140.

Considering that a typical user moves about one meter per second when walking indoors, when a measured position of the user (or user terminal) is significantly changed by 2 meters or more, the control module 150 can directly correct the current position using the second position by determining there is a fluctuation (or sparkling) in RSSI.

According to implementations, the control module 150 can correct the current position of the user terminal 200 by further using the pre-stored spatial information.

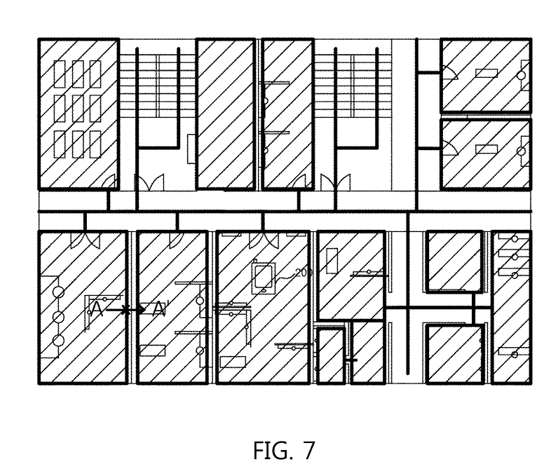

For example, the control module 150 can set movement areas in the space using the spatial information, such that the user can move in the movement areas, and correct the current position of the user terminal 200 based on the set movement areas. An example thereof is illustrated in FIG. 7.

FIG. 7 illustrates an example in which the indoor positioning system having improved accuracy according to embodiments sets movement areas using spatial information.

Referring to FIG. 7, the control module 150 can set movement areas (allowed area for users) in a predetermined space using the spatial information thereof. In an example, the movement areas displayed on the drawing are comprised of areas marked with solid lines and areas marked with dashed lines. The remaining areas (impassable area) of the space may be areas closed by objects, such as walls, or areas in which the user cannot locate due to the structure of the space.

Thus, when the first position measurement module 130 measures that the first position of the user terminal 200 has moved to point A′ directly after being measured at point A, such a movement is actually impossible. In this case, the control module 150 can correct the current position of the user terminal 200 based on the spatial information and the movement areas. For example, as illustrated in the drawing, the position of the user terminal 200 may be estimated to be at the edge of a dashed room, in the three o'clock direction with respect to point A.

According to the technical concept of the present disclosure, it is possible to complementarily correct errors that would occur in each processing, based on the first position of the user terminal measured using the RF transmitters and the second position obtained from the sensing information of the user terminal using PDR. In addition, the use of spatial information allows the first position to be more accurately measured and the current position to be corrected, thereby significantly improving the accuracy of indoor positioning.

In a case in which the position of the user (the position of the user terminal 200) can be accurately measured as described above, a service, such as an indoor navigation service, can be provided to the user. Then, the user can easily find a desired destination in a complicated space at ordinary time and can also be easily provided with an evacuation route in emergency situations such as power failure in which general lighting is not turned on. Alternatively, in a case in which a user is isolated in a space, it is possible to rapidly find and rescue the user by accurately measuring the position of the user terminal 200.

In this regard, the indoor positioning system 100 having improved accuracy may further include the positioning service providing module 160 as described above.

As described above, the positioning service providing module 160 can transmit the current position of the user terminal 200, measured by the control module 150, to the user terminal 200 using the communications module 120. The user terminal 200, upon receiving the current position from the positioning service providing module 160, can easily provide position information to the user by displaying a map of the space on which the current position is marked.

According to implementations, the positioning service providing module 160 can transmit the current position of the user terminal 200 to a predetermined external system (not shown). The external system (not shown) may be a series of systems that needs to recognize the position of the user in the indoor space. Examples of the external system (not shown) may include a management system or a fire protection system that manages the space.

In addition, the positioning service providing module 160 may be configured to allow the user terminal 200 to provide an indoor navigation service by continuously transmitting the current position of the user terminal 200, which is determined by the control module 150, to the user terminal 200 in real time.

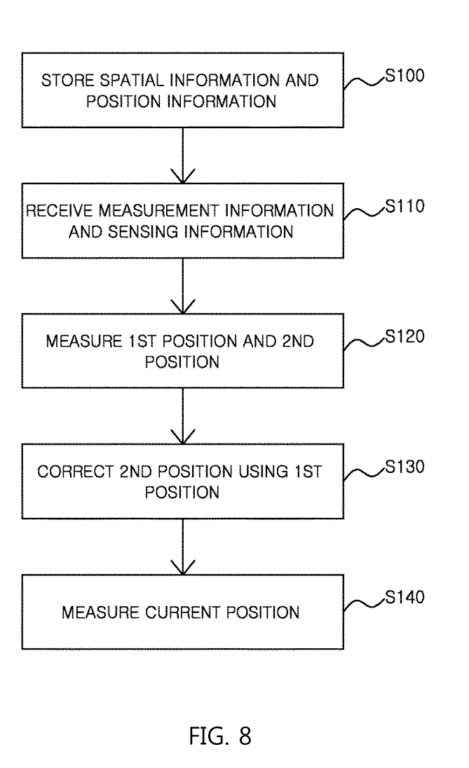

FIG. 8 is a schematic flowchart illustrating the indoor positioning method having improved accuracy according to embodiments.

Referring to FIG. 8, the indoor positioning system 100 having improved accuracy according to embodiments stores the spatial information of a predetermined space and the position information of RF transmitters in the DB 110 (S100). As described above, the spatial information may store the characteristics of various objects located in the space and may further include the correction data for the characteristics of the objects, based on variations in the signal strength of an RF signal when the RF signal passes through the objects located in the space.

Afterwards, the indoor positioning system 100 having improved accuracy receives measurement information and sensing information from the user terminal 200 that has received the RF signal output from the RF transmitter, the sensing information being obtained by sensing the movement of the user terminal 200 (S110). As described above, the measurement information may include identification information and signal strength information of the RF signal received by the user terminal 200. The sensing information is sensed by a variety of sensors of the user terminal 200, such as an inertial sensor or a geomagnetic sensor. The number, length, and direction of steps of the user can be measured based on the sensing information.

Thereafter, the indoor positioning system 100 having improved accuracy measures the first position and the second position of the user terminal 200 based on the measurement information, the spatial information, and the sensing information (S120). Here, the indoor positioning system 100 having improved accuracy can more accurately measure the first position by correcting a distortion in the signal strength of the RF signal output from the user terminal 200, based on the spatial information and the position information of the RF transmitters.

Afterwards, the indoor positioning system 100 having improved accuracy corrects the second position, in which errors would accumulate, by specifying the first position measured using the RF signals as the initial position (S130).

The indoor positioning system 100 having improved accuracy finally measures the current position of the user terminal 200 based on the first position and the second position obtained as described above (S140).

The indoor positioning method having improved accuracy according to embodiments may be embodied as computer readable codes stored in a computer readable recording medium. The computer readable recording medium includes all sorts of record devices in which data readable by a computer system are stored. Examples of the computer readable recording medium include read only memory (ROM), random access memory (RAM), compact disc read only memory (CD-ROM), a magnetic tape, a hard disk, a floppy disk, an optical data storage device and the like. Further, the recording medium may be implemented in the form of a carrier wave (e.g. Internet transmission). In addition, the computer readable recording medium may be distributed to computer systems on the network, in which the computer readable codes are stored and executed in a decentralized fashion. In addition, functional programs, codes and code segments for embodying the present disclosure can be easily construed by programmers having ordinary skill in the art to which the present disclosure pertains.

While the present disclosure has been described with reference to the certain embodiments shown in the drawings, it will be understood by a person skilled in the art that various modifications and equivalent other embodiments may be made therefrom. Therefore, the true scope of the present disclosure shall be defined by the concept of the appended claims.

What is claimed is:

1. An indoor positioning system having improved accuracy, comprising:
a database storing spatial information corresponding to a predetermined space and position information of a plurality of radiofrequency transmitters disposed in the space;
a communications module receiving one or more pieces of measurement information from a user terminal that has received radiofrequency signals output from the plurality of radiofrequency transmitters, the measurement information including identification information of the plurality of radiofrequency transmitters included in the radiofrequency signals and signal strength information of the radiofrequency signals, and sensing information obtained by measuring a movement of the user terminal;
a first position measurement module, when an object is determined to be present between the user terminal and the plurality of radiofrequency transmitters in the space based on the spatial information, the position information and the measurement information, the first position measurement module correcting the signal strength information and measuring a first position of the user terminal based on the corrected signal strength information;
a second position measurement module measuring a second position of the user terminal using pedestrian dead reckoning based on the sensing information; and
a control module measuring a current position of the user terminal by specifying the first position measured by the first position measurement module as an initial position and updating the second position using the specified initial position.

2. The indoor positioning system according to claim 1, wherein, when the pieces of measurement information are received by a number equal to or smaller than a predetermined number, the first position measurement module measures a position of a specific radiofrequency transmitter among the plurality of radiofrequency transmitters as the first position, the signal strength information of the specific radiofrequency transmitter included in the received measurement information being equal to or higher than a predetermined strength or corresponding to highest signal strength information.

3. The indoor positioning system according to claim 1, wherein, when a change per unit time in the first position measured by the first position measurement module is equal to or greater than a predetermined range, the control module corrects the current position using the second position measured by the second position measurement module.

4. The indoor positioning system according to claim 1, wherein the control module sets a movement area in the space using the spatial information, such that a user is allowed to move in the movement area, and corrects the current position of the user terminal based on the movement area.

5. The indoor positioning system according to claim 1, wherein the database further stores characteristics of the object located in the space and correction data according to the characteristics of the object located in the space, the correction data being based on variations in strength of the radiofrequency signals passing through the object.

6. The indoor positioning system according to claim 5, wherein the first position measurement module recognizes the object located in a path, along which a radiofrequency signal among the radiofrequency signals is received by the user terminal, using the spatial information and corrects the signal strength information based on the correction data corresponding to the characteristics of the recognized object.

7. The indoor positioning system according to claim 1, wherein, when the user terminal receives a plurality of radiofrequency signals, the first position measurement module estimates candidate positions according to the plurality of radiofrequency signals received by the user terminal, and when an overlapping common position exists among the candidate positions of the plurality of radiofrequency signals, the first position measurement module measures the common position as the first position of the user terminal.

8. The indoor positioning system according to claim 7, wherein the first position measurement module recognizes the object located at a distance from a radiofrequency transmitter among the plurality of received radiofrequency signals that outputs the specific radiofrequency signal, the distance being equal to or smaller than a distance corresponding to a signal strength of a specific radiofrequency signal, and estimates a candidate position corresponding to the specific radiofrequency signal based on the signal strength corrected using correction data corresponding to the recognized object.

9. The indoor positioning system according to claim 1, wherein the control module changes at least one period of a period of time for which the initial position is specified and a period of time for which the first position measurement module measures the first position to be different, depending on at least one of factors determined by the first position measurement module, the factors including presence or absence of the object between the user terminal and the plurality of radiofrequency transmitters determined by the first position measurement module, the number of the objects located in the path, and characteristics of the objects.

10. An indoor positioning method comprising:
storing, by an indoor positioning system having improved accuracy, spatial information corresponding to a predetermined space and position information regarding a plurality of radiofrequency transmitters disposed in the space;
receiving, by the indoor positioning system, one or more pieces of measurement information from a user terminal that has received radiofrequency signals output from the plurality of radiofrequency transmitters, the measurement information including identification information of the plurality of radiofrequency transmitters included in the radiofrequency signals and signal strength information of the radiofrequency signals, and sensing information obtained by measuring a movement of the user terminal;
when an object is determined to be present between the user terminal and the plurality of radiofrequency transmitters in the space based on the spatial information, the position information, and the measurement information, correcting, by the indoor positioning system, the signal strength information and measuring a first position of the user terminal based on the corrected signal strength information;
measuring, by the indoor positioning system, a second position of the user terminal using pedestrian dead reckoning based on the sensing information; and
measuring, by the indoor positioning system, a current position of the user terminal by specifying the first position measured by the first position measurement module as an initial position and updating the second position using the specified initial position.

11. The indoor positioning method according to claim 10, wherein, in the process of receiving the one or more pieces of measurement information from the user terminal that has received the radiofrequency signals output from the plurality of radiofrequency transmitters,
when the pieces of measurement information are received by a number equal to or smaller than a predetermined number, the indoor positioning system measures a position of a specific radiofrequency transmitter among the plurality of radiofrequency transmitters as the first position,
the signal strength information of the specific radiofrequency transmitter included in the received measurement information being equal to or higher than a predetermined strength or corresponding to highest signal strength information.

12. The indoor positioning method according to claim 10, wherein, in the process of measuring the current position of the user terminal by specifying the first position measured by the first position measurement module as the initial position and updating the second position using the specified initial position,
when a change per unit time in the first position measured by the first position measurement module is equal to or greater than a predetermined range,
the indoor positioning system corrects the current position using the second position measured by the second position measurement module.

13. The indoor positioning method according to claim 10, further comprising:
setting, by the indoor positioning system, a movement area in the space using the spatial information, such that a user is allowed to move in the movement area; and
correcting, by the indoor positioning system, the current position of the user terminal based on the movement area.

14. The indoor positioning method according to claim 10, wherein, in the process of storing the spatial information corresponding to the space and the position information of the plurality of radiofrequency transmitters disposed in the space,
the indoor positioning system stores characteristics of the object located in the space and correction data according to the characteristics of the object located in the space, the correction data being based on variations in strength of the radiofrequency signals passing through the object.

15. The indoor positioning method according to claim 14, wherein, in the process of correcting the signal strength information and measuring the first position of the user terminal based on the corrected signal strength information,
the indoor positioning system recognizes the object located in a path, along which a radiofrequency signal among the radiofrequency signals is received by the user terminal, using the spatial information and corrects the signal strength information based on the correction data corresponding to the characteristics of the recognized object.

16. The indoor positioning method according to claim 10, wherein, in the process of measuring the current position of the user terminal by specifying the first position measured by the first position measurement module as the initial position and updating the second position using the specified initial position,
the indoor positioning system changes at least one period of a period of time for which the initial position is specified and a period of time for which the first position measurement module measures the first position to be different, depending on at least one of factors determined by the first position measurement module, the factors including presence or absence of the object between the user terminal and the radiofrequency transmitter, the number of the objects located in the path, and characteristics of the objects.

17. A computer program recorded in a recording medium disposed in a data processor to carry out the method as claimed in claim 11.
